(19) United States
(12) Patent Application Publication
(10) Pub. No.: US 2002/0085023 A1
(43) Pub. Date: Jul. 4, 2002

(54) Display of ancillary data on local network appliance

(76) Inventors: Fred J. Zustak, Poway, CA (US); Matthew S. Chang, San Diego, CA (US); Aditya Krishnan, San Diego, CA (US); Andrew M. Proehl, San Francisco, CA (US); David K. L. Yang, San Diego, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/752,954

(22) Filed: Jan. 2, 2001

(51) Int. Cl. G09G 5/00

(52) U.S. Cl. 345/733

(57) ABSTRACT

Interactive programming ancillary data are displayed on a local network appliance. A user elects to receive the ancillary data by making a control selection resulting in a set-top box obtaining the ancillary data and transmitting the ancillary data or information generated from the ancillary data to a local network appliance. The local network appliance displays the data so that the television viewing experience is not disturbed by windows or other intrusive means obscuring a portion of the television display.

### FIELD OF THE INVENTION

This invention relates generally to the field of television. More particularly, this invention relates to a method and apparatus for viewing electronic program guides or other ancillary information associated with television programming on a local network appliance.

### BACKGROUND OF THE INVENTION

Interactive television is currently available in a Wink™ compliant format from Wink Communications of Alameda, Calif. Other interactive television services including ATVEF (Advanced TeleVision Enhancement Forum) compliant programming are also expected to be available in the near future. In accordance with one scenario, a universal resource locator (URL) pointing to program information or the program information itself may be incorporated as interactive content within a television program. In this scenario, when the user wishes to obtain additional information by viewing the interactive content, he or she actuates a switch on his remote controller to retrieve a web page or other content associated with the content. This content is then available to the user in a window within the television programming. In the case of a URL, a service provider then downloads the page corresponding to the URL for viewing by the user.

In existing television services using electronic program guides (EPGs), a user typically elects to view the electronic program guide by actuating a button on a remote controller to retrieve the EPG. The EPG is then presented in a grid format, or other format, to the user. In some cases, the currently selected channel is shown in a smaller window so the user can continue viewing, but in others the viewing of a program is interrupted.

For purposes of this document, the term “ancillary data” is used to refer to either EPG information or interactive television programming available, for example as ATVEF or Wink™ compliant data, or other data associated with television programming that can be retrieved by a viewer. This data can be provided as a part of the television signal or as a separate data signal without limitation.

Unfortunately, for both EPG information and ancillary information provided in interactive television programming using ATVEF or Wink™ or other formats, the user is generally at least partially obscured from viewing the television programming if he or she desires to view either the EPG to select a future selection or view ancillary data associated with the interactive programming. The present invention addresses this problem.

### SUMMARY OF THE INVENTION

The present invention relates generally to viewing of ancillary data in an interactive television environment. Objects, advantages and features of the invention will become apparent to those skilled in the art upon consideration of the following detailed description of the invention.

In one embodiment of the present invention interactive programming ancillary data are displayed on a local network appliance. A user elects to receive the ancillary data by making a control selection resulting in a set-top box obtaining the ancillary data and transmitting the ancillary data, or information generated from the ancillary data, to a local network appliance. The local network appliance displays the data so that the television viewing experience is not disturbed by windows or other intrusive means obscuring a portion of the television display.

In one embodiment consistent with the invention, a method of displaying ancillary data associated with an interactive television program includes retrieving the ancillary data; and transmitting information, the information comprising one of the ancillary data and data generated from the ancillary data, to a local network appliance for display.

In another embodiment consistent with the invention, a method of displaying ancillary data associated with an interactive television program includes receiving the ancillary data at a local network appliance; and displaying information, the information comprising one of the ancillary data and data generated from the ancillary data, on a display of the local network appliance.

An electronic storage medium storing instructions which, when executed on a programmed processor, carry out a method of displaying ancillary data associated with an interactive television program consistent with embodiments of the invention includes retrieving the ancillary data; and transmitting a representation of the ancillary data to a local network appliance for display.

Another electronic storage medium storing instructions which, when executed on a programmed processor, carry out a method of displaying ancillary data associated with an interactive television program consistent with the invention includes receiving the ancillary data at a local network appliance; and displaying a representation of the ancillary data on a display of the local network appliance.

Another method, consistent with embodiments of the inention, of displaying ancillary data associated with an interactive television program includes receiving a command via a wireless receiver to retrieve the ancillary data; retrieving the ancillary data; transmitting, via a wireless transmitter, the ancillary data to a local network appliance for display for a period of time established by a timer; transmitting an advertisement using the wireless transmitter to the local network appliance for display at a time when the ancillary data is not being displayed; wherein the ancillary data comprises one of an electronic program guide, Wink™ compliant ancillary data and ATVEF compliant ancillary data; wherein the transmitting and receiving are carried out using Bluetooth compliant wireless communication; and wherein the local network appliance further comprises one of a data pad, palmtop computer, telephone and remote controller.

A local network appliance consistent with embodiments of the invention includes a receiver that receives a representation of the ancillary data. A display displays the representation of the ancillary data at the local network appliance.

A set-top box consistent with certain embodiments of the invention includes a receiver that receives a command to retrieve ancillary data associated with an interactive television program. A programmed processor operating under program control retrieves the ancillary data. A transmitter transmits a representation of the ancillary data to a local network appliance for display.

A method of advertising consistent with embodiments of the invention includes transmitting an advertisement from a set-top box to a local network appliance; receiving the advertisement at the local network appliance; and displaying the advertisement on a display of the local network appliance.

An electronic storage medium storing instructions which, when executed on a programmed processor, carry out a method of advertising consistent with embodiments of the invention includes at the local network appliance, receiving an advertisement transmitted from a set-top box to the local network appliance; and displaying the advertisement on a display of the local network appliance.

A set-top box consistent with embodiments of the invention includes a receiver that receives a command to retrieve ancillary data associated with an interactive television program. A programmed processor operates under program control to retrieve the ancillary data and generate a graphical representation of the ancillary data suitable for display on a display. A transmitter transmits the graphical representation of the ancillary data to a local network appliance for display.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a flow chart depicting one embodiment of the invention.

FIG. 4 is a flow chart depicting another embodiment of the invention.

FIG. 5 is a block diagram of a wireless local network appliance consistent with embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

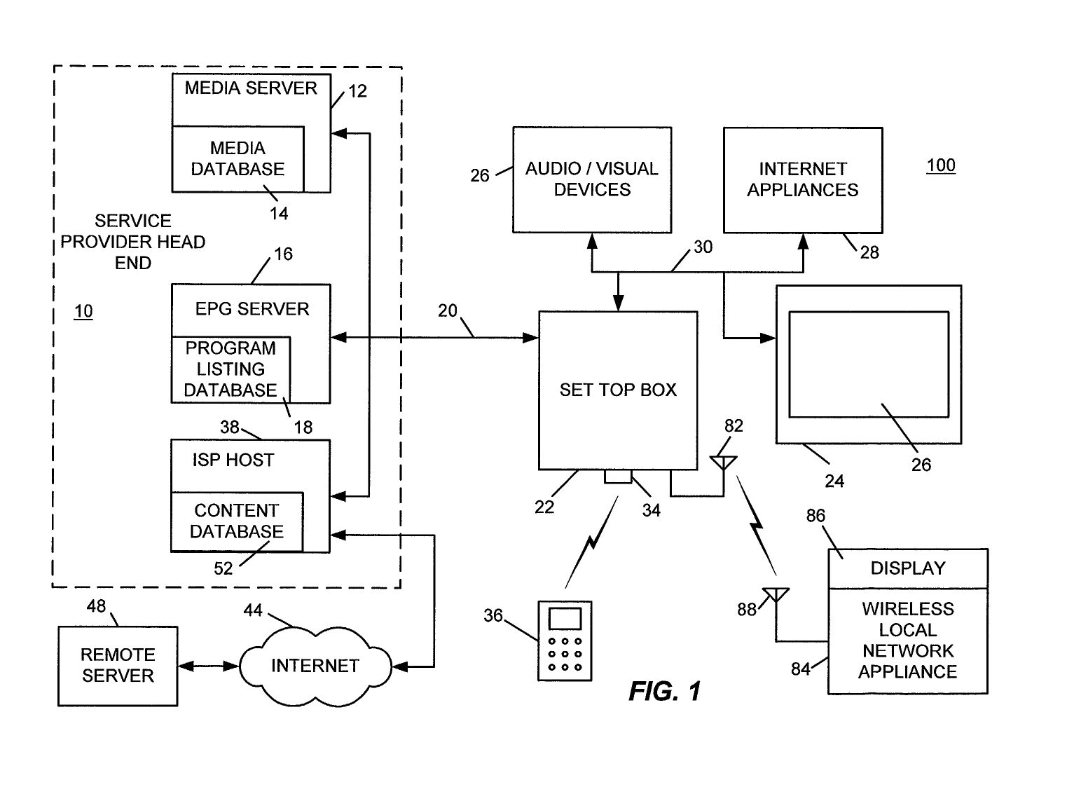

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

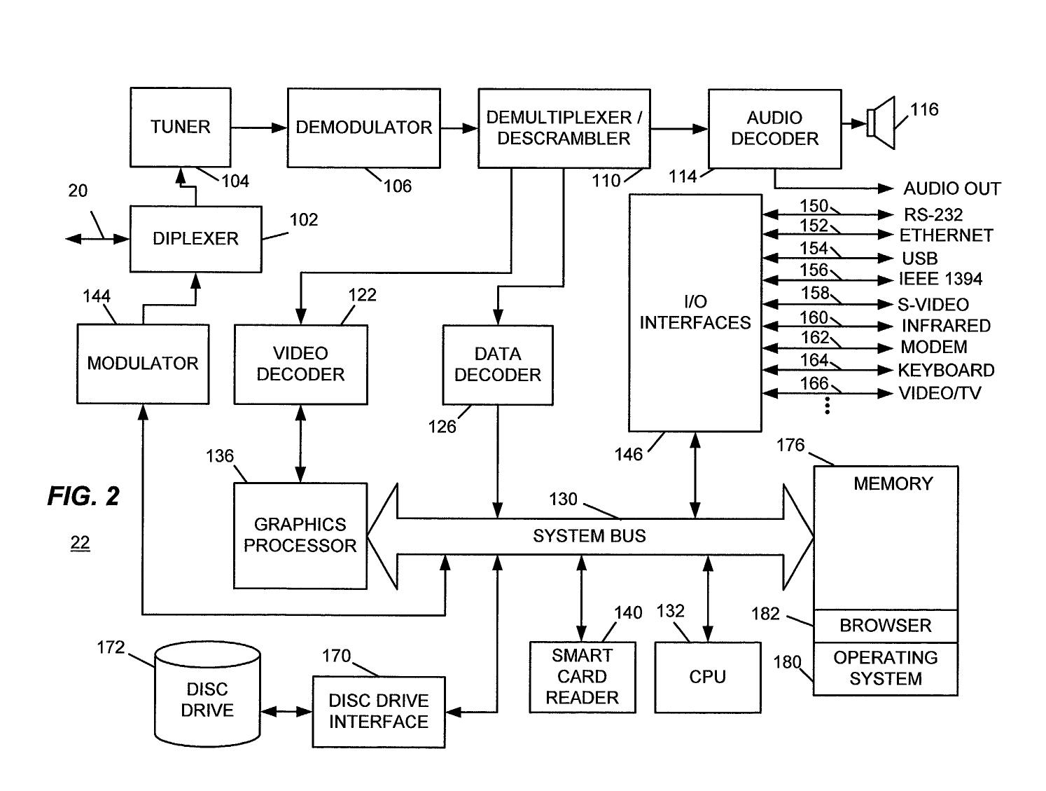

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window - often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

Referring back to FIG. 1, in accordance with certain embodiments of the present invention, the STB 22 may incorporate a wireless interface, such as a Bluetooth compliant interface, coupled to an antenna 82 for transmitting and receiving data. In addition to connected Internet appliances 28, the system may include wired or wireless local network appliances such as the exemplary wireless local network appliance 84. As shown, the wireless local network appliance 84 includes a display 86, such as a liquid crystal display (LCD), and a suitable antenna 88 for communication with the STB 22. In accordance with other embodiments, other wired or wireless local network appliances, including remote controller 36, may be used to embody the present invention.

In accordance with embodiments of the present invention, rather than obscuring the screen 26 with the EPG or other ancillary data, the ancillary data is transmitted to a local network appliance, such as the wireless local network appliance 84, for display on display 86. Wireless local network appliance 84 may represent, for example, a data pad, palmtop computer, cellular or cordless telephone, or remote controller.

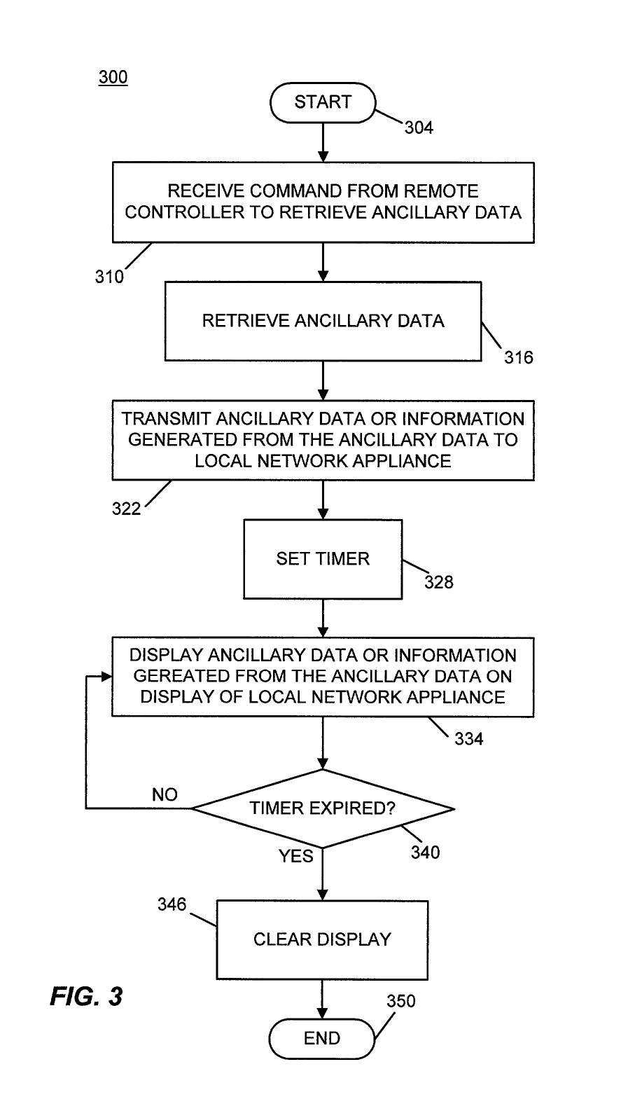

Referring now to FIG. 3, one process consistent with embodiments of the present invention is illustrated as process 300. This process describes actions carried out by both the STB 22 and the local network appliance 84 from a system perspective and can be implemented using programmed processors present in both the STB 22 and the local network appliance 84. The process starts at 304 after which a command is received from the remote controller at 310 to retrieve the desired ancillary data. The ancillary data are retrieved at 316 and transmitted to the local network appliance at 322. The transmission at 322 can be either the actual ancillary data itself or information generated from the ancillary data. For example, the STB 22 can generate screen images from the ancillary data and only transmit the screen images to the network appliance in one embodiment. In other embodiments, the ancillary data can be manipulated (e.g., enhanced, decompressed, formatted, etc.) in other ways and the manipulated data transmitted to the network appliance. In this manner, the computing burden can be handled by the STB 22 so that the network appliance 28 can be as simple and inexpensive as possible.

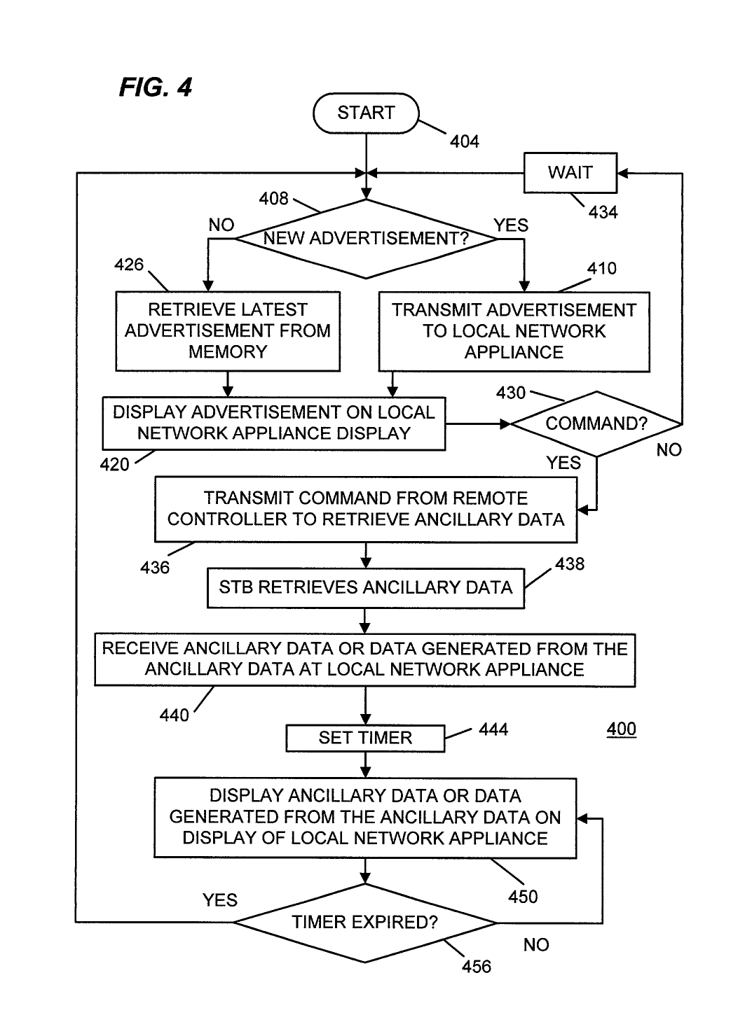

In the current embodiment, the ancillary data are displayed on the local network appliance for a defined period of time established by setting a timer at 328. The ancillary data are displayed on the display 86 of the local network appliance at 334 until the timer expires at 340. Control then passes to 346 where the display is cleared and the process ends at 350. Many variations of this process will occur to those skilled in the art. For example, the displayed ancillary data can remain on the display until the user clears the display manually. FIG. 4 depicts an alternative embodiment of a process 400 consistent with the invention in which advertisements are displayed during times when the ancillary data are not present or when the ancillary data are being downloaded. This process 400 begins at 404 after which either the STB 22 or the local network appliance determines at 408 that a new advertisement is available. If so, the advertisement is transmitted to the local network appliance at 410 and the advertisement is displayed on the local network appliance's display at 420.

If a new advertisement is not available at 408, the latest advertisement (or another advertisement) is retrieved from memory either in STB 22 or the local network appliance 84 for display at 420. In either case, control passes to 430 where it is determined if a command has been entered at the local network appliance. If not, control passes back to 408 after a wait time at 434. If a command is received at 430, the command is transmitted from the local network appliance to the STB 22 requesting particular ancillary data at 436. This can be done in any suitable manner such as pointing to the desired data or an icon using the remote controller (which may in fact be the local network appliance).

The STB 22 retrieves the ancillary data in any suitable manner as defined by the operational parameters of the particular interactive television system at 438 and transmits the ancillary data (or information generated from the ancillary data as discussed earlier) for receipt at the local network appliance at 440. At 444, a timer is set to determine the amount of time the ancillary data are to be displayed. At 450 the ancillary data are displayed on the display of the local network appliance until the timer expires at 456. Control then returns to 408 to inspect for a new advertisement. Many variations of this process are possible without departing from the invention.

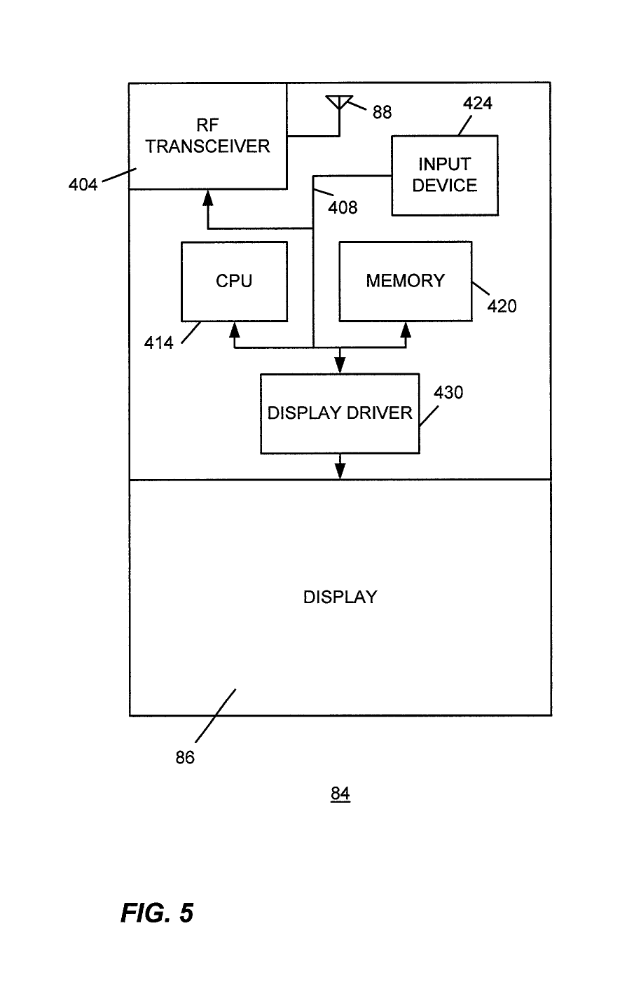

An exemplary wireless local network appliance 84 is illustrated in block diagram form in FIG. 5. In this exemplary system, the antenna 88 is illustrated as an internal antenna residing within the housing of the wireless local network appliance 84. In other embodiments, an external antenna can be used. The antenna 88 is coupled to an RF transceiver 404 that transmits and receives radio frequency modulated data using, for example, the Bluetooth standard or any other suitable wireless communication technique. In other embodiments, an infrared, or a wired interface can be used instead of the RF interface described.

The RF transceiver 404 is coupled to a system bus 408 using a suitable interface to permit data exchange with a central processor 414. A memory 420 is coupled to the bus 408 and carries the ancillary data as well as an operating system and programmed instructions for carrying out the process according to the present invention. An input device such as a touch screen, key pad or other suitable input device 424 is provided to accept user commands. Those commands can include television control commands as well as commands used to provide responses to interactive programming. Ancillary data are displayed on display 86 by addressing data from the central processor 414 to a display driver 430 to appropriately drive the display 86.

Of course, the circuitry represented by the block diagram shown in FIG. 4 can be a part of a system such as a data pad, palmtop computer, telephone, remote controller, etc. so that the functions described herein are in addition to the normal functions carried out by the system, without departing from the invention.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program instructions used to implement the embodiments described above can be stored using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and may be stored in an electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of displaying ancillary data associated with an interactive television program, comprising:
retrieving the ancillary data; and
transmitting information, the information comprising one of the ancillary data and data generated from the ancillary data, to a local network appliance for display.

2. The method according to claim 1, further comprising receiving a command to retrieve the ancillary data.

3. The method according to claim 1, further comprising transmitting an advertisement to the local network appliance for display.

4. The method according to claim 1, further comprising transmitting an advertisement to the local network appliance for display at a time when the information is not being displayed.

5. The method according to claim 1, wherein the transmitting and receiving are carried out using wireless transmitting and receiving.

6. The method according to claim 1, wherein the ancillary data comprise an electronic program guide.

7. The method according to claim 1, wherein the ancillary data comprise Wink™ compliant ancillary data.

8. The method according to claim 1, wherein the ancillary data comprise ATVEF compliant ancillary data.

9. The method according to claim 1, wherein the information displayed for a period of time established by a timer.

10. The method according to claim 1, wherein the transmitting and receiving are carried out using Bluetooth compliant wireless communication.

11. The method according to claim 1, wherein the local network appliance further comprises one of a data pad, palmtop computer, telephone and remote controller.

12. A method of displaying ancillary data associated with an interactive television program, comprising:
receiving the ancillary data at a local network appliance; and
displaying information, the information comprising one of the ancillary data and data generated from the ancillary data, on a display of the local network appliance.

13. The method according to claim 12, further comprising transmitting a command to retrieve the ancillary data.

14. The method according to claim 12, further comprising receiving an advertisement at the local network appliance for display.

15. The method according to claim 12, further comprising receiving an advertisement at the local network appliance for display at a time when the information is not being displayed.

16. The method according to claim 12, wherein the transmitting and receiving are carried out using wireless transmitting and receiving.

17. The method according to claim 12, wherein the ancillary data comprise an electronic program guide.

18. The method according to claim 12, wherein the ancillary data comprise Wink™ compliant ancillary data.

19. The method according to claim 12, wherein the ancillary data comprise ATVEF compliant ancillary data.

20. The method according to claim 12, wherein the information is displayed for a period of time established by a timer.

21. The method according to claim 12, wherein the transmitting and receiving are carried out using Bluetooth compliant wireless communication.

22. The method according to claim 12, wherein the local network appliance further comprises one of a data pad, palmtop computer, telephone and remote controller.

23. An electronic storage medium storing instructions which, when executed on a programmed processor, carry out a method of displaying ancillary data associated with an interactive television program, comprising:
retrieving the ancillary data; and
transmitting a representation of the ancillary data to a local network appliance for display.

24. The method according to claim 23, further comprising receiving a command to retrieve the ancillary data.

25. The storage medium according to claim 23, further comprising transmitting an advertisement to the local network appliance for display.

26. The storage medium according to claim 23, further comprising transmitting an advertisement to the local network appliance for display at a time when the representation of the ancillary data is not being displayed.

27. The storage medium according to claim 23, wherein the transmitting and receiving are carried out using wireless transmitting and receiving.

28. The storage medium according to claim 23, wherein the ancillary data comprise an electronic program guide.

29. The storage medium according to claim 23, wherein the ancillary data comprise Wink™ compliant ancillary data.

30. The storage medium according to claim 23, wherein the ancillary data comprise ATVEF compliant ancillary data.

31. The storage medium according to claim 23, wherein the ancillary data are displayed for a period of time established by a timer.

32. The storage medium according to claim 23, wherein the transmitting and receiving are carried out using Bluetooth compliant wireless communication.

33. The storage medium according to claim 23, wherein the local network appliance further comprises one of a data pad, palmtop computer, telephone and remote controller.

34. An electronic storage medium storing instructions which, when executed on a programmed processor, carry out a method of displaying ancillary data associated with an interactive television program, comprising:
receiving the ancillary data at a local network appliance; and
displaying a representation of the ancillary data on a display of the local network appliance.

35. The method according to claim 34, further comprising transmitting a command to retrieve the ancillary data.

36. The storage medium according to claim 34, further comprising receiving an advertisement at the local network appliance for display at a time when the representation of the ancillary data is not being displayed.

37. The storage medium according to claim 34, wherein the transmitting and receiving are carried out using wireless transmitting and receiving.

38. The storage medium according to claim 34, wherein the ancillary data comprise an electronic program guide.

39. The storage medium according to claim 34, wherein the ancillary data comprise Wink™ compliant ancillary data.

40. The storage medium according to claim 34, wherein the ancillary data comprise ATVEF compliant ancillary data.

41. The storage medium according to claim 34, wherein the representation of the ancillary data is displayed for a period of time established by a timer.

42. The storage medium according to claim 34, wherein the transmitting and receiving are carried out using Bluetooth compliant wireless communication.

43. The storage medium according to claim 34, wherein the local network appliance further comprises one of a data pad, palmtop computer, telephone and remote controller.

44. A method of displaying ancillary data associated with an interactive television program, comprising:
receiving a command via a wireless receiver to retrieve the ancillary data;
retrieving the ancillary data;
transmitting, via a wireless transmitter, the ancillary data to a local network appliance for display for a period of time established by a timer;
transmitting an advertisement using the wireless transmitter to the local network appliance for display at a time when the ancillary data is not being displayed;
wherein the ancillary data comprises one of an electronic program guide, Wink™ compliant ancillary data and ATVEF compliant ancillary data;
wherein the transmitting and receiving are carried out using Bluetooth compliant wireless communication; and
wherein the local network appliance further comprises one of a data pad, palmtop computer, telephone and remote controller.

45. A local network appliance, comprising:
a receiver that receives a representation of the ancillary data; and
a display that displays the representation of the ancillary data at the local network appliance.

46. The apparatus according to claim 45, further comprising a transmitter that transmits a command to retrieve ancillary data associated with an interactive television program.

47. The apparatus according to claim 45, wherein the receiver further receives an advertisement at the local network appliance for display at a time when the representation of the ancillary data is not being displayed.

48. The apparatus according to claim 45, wherein the transmitting and receiving are carried out using wireless transmitting and receiving.

49. The apparatus according to claim 45, wherein the ancillary data comprise an electronic program guide.

50. The apparatus according to claim 45, wherein the ancillary data comprise Wink™ compliant ancillary data.

51. The apparatus according to claim 45, wherein the ancillary data comprise ATVEF compliant ancillary data.

52. The apparatus according to claim 45, wherein the representation of the ancillary data is displayed for a period of time established by a timer.

53. The apparatus according to claim 45, wherein the transmitting and receiving are carried out using Bluetooth compliant wireless communication.

54. The apparatus according to claim 45, wherein the local network appliance further comprises one of a data pad, palmtop computer, telephone and remote controller.

55. A set-top box, comprising:
a receiver that receives a command to retrieve ancillary data associated with an interactive television program;
a programmed processor operating under program control to retrieve the ancillary data; and
a transmitter that transmits a representation of the ancillary data to a local network appliance for display.

56. The apparatus according to claim 55, wherein the receiver further receives an advertisement at the local network appliance for display at a time when the representation of the ancillary data is not being displayed.

57. The apparatus according to claim 55, wherein the transmitting and receiving are carried out using wireless transmitting and receiving.

58. The apparatus according to claim 55, wherein the ancillary data comprise an electronic program guide.

59. The apparatus according to claim 55, wherein the ancillary data comprise Wink™ compliant ancillary data.

60. The apparatus according to claim 55, wherein the ancillary data comprise ATVEF compliant ancillary data.

61. The apparatus according to claim 55, wherein the representation of the ancillary data are displayed for a period of time established by a timer.

62. The apparatus according to claim 55, wherein the transmitting and receiving are carried out using Bluetooth compliant wireless communication.

63. The apparatus according to claim 55, wherein the local network appliance further comprises one of a data pad, palmtop computer, telephone and remote controller.

64. The apparatus according to claim 55, wherein the representation of the ancillary data comprises graphics data suitable for display on a display of the network appliance.

65. The apparatus according to claim 55, wherein the representation of the ancillary data comprises an encoded version of the ancillary data.

66. A method of advertising, comprising:
transmitting an advertisement from a set-top box to a local network appliance;
receiving the advertisement at the local network appliance; and
displaying the advertisement on a display of the local network appliance.

67. The method according to claim 66, wherein the transmitting and receiving are carried out using wireless transmitting and receiving.

68. The method according to claim 66, wherein the transmitting and receiving are carried out using Bluetooth compliant wireless communication.

69. The method according to claim 66, wherein the local network appliance further comprises one of a data pad, palmtop computer, telephone and remote controller.

70. An electronic storage medium storing instructions which, when executed on a programmed processor, carry out a method of advertising, comprising:
at the local network appliance, receiving an advertisement transmitted from a set-top box to the local network appliance; and
displaying the advertisement on a display of the local network appliance.

71. The electronic storage medium according to claim 70, wherein the transmitting and receiving are carried out using wireless transmitting and receiving.

72. The electronic storage medium according to claim 70, wherein the transmitting and receiving are carried out using Bluetooth compliant wireless communication.

73. The electronic storage medium according to claim 70, wherein the local network appliance further comprises one of a data pad, palmtop computer, telephone and remote controller.

74. A set-top box, comprising:
a receiver that receives a command to retrieve ancillary data associated with an interactive television program;
a programmed processor operating under program control to retrieve the ancillary data and generate a graphical representation of the ancillary data suitable for display on a display; and
a transmitter that transmits the graphical representation of the ancillary data to a local network appliance for display.

75. The apparatus according to claim 74, wherein the receiver further receives an advertisement at the local network appliance for display at a time when the graphical representation of the ancillary data is not being displayed.
